(19) United States
(12) Patent Application Publication
(10) Pub. No.: US 2021/0241201 A1
(43) Pub. Date: Aug. 5, 2021

(54) TECHNIQUES FOR BENCHMARKING PAIRING STRATEGIES IN A TASK ASSIGNMENT SYSTEM

(71) Applicant: Afiniti, Ltd., Hamilton (BM)

(72) Inventors: Zia CHISHTI, Washington, DC (US); Julian LOPEZ-PORTILLO, Mexico City (MX); Ittai KAN, McLean, VA (US)

(73) Assignee: Afiniti, Ltd., Hamilton (BM)

(21) Appl. No.: 17/163,668

(22) Filed: Feb. 1, 2021

Related U.S. Application Data
(60) Provisional application No. 62/970,520, filed on Feb. 5, 2020.

(51) Int. Cl. G06Q 10/06; H04M 3/51; H04M 3/523

(52) U.S. Cl. CPC G06Q 10/06393; G06Q 10/0633; H04M 3/5233; H04M 3/5175; G06Q 10/063112

(57) ABSTRACT

Techniques for benchmarking pairing strategies in a task assignment system are disclosed. In one particular embodiment, the techniques may be realized as a method for benchmarking pairing strategies in a task assignment system, the method comprising: determining, by at least one computer processor communicatively coupled to and configured to operate in the task assignment system, a first performance of a first pairing strategy based at least in part on a first plurality of historical task assignments assigned by a second pairing strategy.

### CROSS-REFERENCE TO RELATED APPLICATIONS

This patent application claims priority to U.S. Provisional Patent Application No. 62/970,520, filed Feb. 5, 2020, which is hereby incorporated by reference herein in its entirety.

### FIELD OF THE DISCLOSURE

The present disclosure generally relates to task assignment systems and, more particularly, to techniques for benchmarking pairing strategies in a task assignment system.

### BACKGROUND OF THE DISCLOSURE

A typical task assignment system algorithmically assigns tasks arriving at the task assignment system to agents available to handle those tasks. At times, the task assignment system may be in an “L1 state” and have agents available and waiting for assignment to tasks. At other times, the task assignment system may be in an “L2 state” and have tasks waiting in one or more queues for an agent to become available for assignment. At yet other times, the task assignment system may be in an “L3 state” and have multiple agents available and multiple tasks waiting for assignment.

Some traditional task assignment systems assign tasks to agents ordered based on time of arrival, and agents receive tasks ordered based on the time when those agents became available. This strategy may be referred to as a “first-in, first-out,” “FIFO,” or “round-robin” strategy. For example, in an L2 environment, when an agent becomes available, the task at the head of the queue would be selected for assignment to the agent.

Other traditional task assignment systems may implement a performance-based routing (PBR) strategy for prioritizing higher-performing agents for task assignment. Under PBR, for example, the highest-performing agent among available agents receives the next available task.

“Behavioral Pairing” or “BP” strategies, for assigning tasks to agents, improve upon traditional pairing methods. BP targets balanced utilization of agents while simultaneously improving overall task assignment system performance potentially beyond what FIFO or PBR methods will achieve in practice.

Some typical task assignment systems benchmark the relative performance of multiple pairing strategies. For example, a task assignment system may use a FIFO strategy (or some other traditional pairing strategy, e.g., PBR) for some tasks and a BP strategy for other tasks. The task assignment system may cycle the BP strategy on and off, collecting outcome data during the “ON” (BP) cycle and the “OFF” (FIFO) cycle, and determine the relative performance gain of the BP strategy over the FIFO strategy. In these task assignment systems, the BP strategy may outperform the FIFO strategy. Thus, the greater amount of time the BP strategy is ON, the more opportunities there are to optimize task-agent pairings using the BP strategy. However, if the OFF cycle is too short, there may be insufficient OFF sample data to calculate the OFF (“baseline”) performance accurately.

Thus, it may be understood that there may be a need for a task assignment system with benchmarking that can work for longer ON cycles without sacrificing the accuracy of the benchmark.

### SUMMARY OF THE DISCLOSURE

Techniques for benchmarking pairing strategies in a task assignment system are disclosed. In one particular embodiment, the techniques may be realized as a method for benchmarking pairing strategies in a task assignment system, the method comprising: determining, by at least one computer processor communicatively coupled to and configured to operate in the task assignment system, a first performance of a first pairing strategy based at least in part on a first plurality of historical task assignments assigned by a second pairing strategy.

In accordance with other aspects of this particular embodiment, the task assignment system is a contact center system.

In accordance with other aspects of this particular embodiment, the first pairing strategy is a first-in, first-out strategy.

In accordance with other aspects of this particular embodiment, the second pairing strategy is a behavioral pairing strategy.

In accordance with other aspects of this particular embodiment, the determining the first performance may further be based at least in part on a second plurality of historical task assignments assigned by the first pairing strategy.

In accordance with other aspects of this particular embodiment, the method may further comprise improving, by the at least one computer processor, a pairing model of the second pairing strategy by determining, based on both the first plurality of historical task assignments and the second plurality of historical task assignments, a performance for each feasible task-agent combination.

In accordance with other aspects of this particular embodiment, the first performance may be based solely on the first plurality of historical task assignments assigned by the second pairing strategy.

In accordance with other aspects of this particular embodiment, the task assignment system may apply the second pairing strategy at least 90% of the time.

In accordance with other aspects of this particular embodiment, the task assignment system may apply the second pairing strategy 100% of the time.

In accordance with other aspects of this particular embodiment, the determining the first performance may further comprise weighting the first plurality of historical task assignments according to an expected distribution of task assignments when using the first pairing strategy.

In accordance with other aspects of this particular embodiment, the method may further comprise determining, by the at least one computer processor, a second performance of the second pairing strategy based at least in part on the first plurality of historical task assignments.

In accordance with other aspects of this particular embodiment, the first plurality of historical task assignments may be weighted for determining the first performance of the first pairing strategy, and the first plurality of historical task assignments may be unweighted for determining the second performance of the second pairing strategy.

In another particular embodiment, the techniques may be realized as a system for benchmarking pairing strategies in a task assignment system comprising at least one computer processor communicatively coupled to and configured to operate in the task assignment system, wherein the at least one computer processor is further configured to perform the steps in the above-described method.

In another particular embodiment, the techniques may be realized as an article of manufacture for benchmarking pairing strategies in a task assignment system comprising a non-transitory processor readable medium and instructions stored on the medium, wherein the instructions are configured to be readable from the medium by at least one computer processor communicatively coupled to and configured to operate in the task assignment system and thereby cause the at least one computer processor to operate so as to perform the steps in the above-described method.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

To facilitate a fuller understanding of the present disclosure, reference is now made to the accompanying drawings, in which like elements are referenced with like numerals. These drawings should not be construed as limiting the present disclosure but are intended to be illustrative only.

FIG. 1 shows a block diagram of a task assignment system according to embodiments of the present disclosure.

FIG. 2 shows a block diagram of a pairing system according to embodiments of the present disclosure.

FIGS. 3A-3D show representative distributions of task-agent assignments according to embodiments of the present disclosure.

FIG. 4 shows a flow diagram of a benchmarking method for benchmarking paring strategies in a task assignment system according to embodiments of the present disclosure.

### DETAILED DESCRIPTION

A typical task assignment system algorithmically assigns tasks arriving at the task assignment system to agents available to handle those tasks. At times, the task assignment system may be in an “L1 state” and have agents available and waiting for assignment to tasks. At other times, the task assignment system may be in an “L2 state” and have tasks waiting in one or more queues for an agent to become available for assignment. At yet other times, the task assignment system may be in an “L3 state” and have multiple agents available and multiple tasks waiting for assignment. An example of a task assignment system is a contact center system that receives contacts (e.g., telephone calls, internet chat sessions, emails, etc.) to be assigned to agents.

Some traditional task assignment systems assign tasks to agents ordered based on time of arrival, and agents receive tasks ordered based on the time when those agents became available. This strategy may be referred to as a “first-in, first-out,” “FIFO,” or “round-robin” strategy. For example, in an L2 environment, when an agent becomes available, the task at the head of the queue would be selected for assignment to the agent.

Other traditional task assignment systems may implement a performance-based routing (PBR) strategy for prioritizing higher-performing agents for task assignment. Under PBR, for example, the highest-performing agent among available agents receives the next available task.

“Behavioral Pairing,” or “BP” strategies, provides for assigning tasks to agents that improves upon traditional pairing methods. BP targets balanced utilization of agents while simultaneously improving overall task assignment system performance potentially beyond what FIFO or PBR methods will achieve in practice. This is a remarkable achievement inasmuch as BP acts on the same tasks and same agents as FIFO or PBR methods, approximately balancing the utilization of agents as FIFO provides, while improving overall task assignment system performance beyond what either FIFO or PBR provides in practice. BP improves performance by assigning agent and task pairs in a fashion that takes into consideration the assignment of potential subsequent agent and task pairs such that, when the benefits of all assignments are aggregated, they may exceed those of FIFO and PBR strategies.

Various BP strategies may be used, such as a diagonal model BP strategy or a network flow BP strategy. These task assignment strategies and others are described in detail for a contact center context in, e.g., U.S. Pat. Nos. 9,300,802, 9,781,269, 9,787,841, and 9,930,115, all of which are hereby incorporated by reference herein. BP strategies may be applied in an L1 environment (agent surplus, one task; select among multiple available/idle agents), an L2 environment (task surplus, one available/idle agent; select among multiple tasks in queue), and an L3 environment (multiple agents and multiple tasks; select among pairing permutations).

Some typical task assignment systems benchmark the relative performance of multiple pairing strategies. For example, a task assignment system may use a FIFO strategy (or some other traditional pairing strategy, e.g., PBR) for some tasks and a BP strategy for other tasks. The task assignment system may cycle the BP strategy on and off, collecting outcome data during the “ON” (BP) cycle and the “OFF” (FIFO) cycle, and determine the relative performance gain of the BP strategy over the FIFO strategy. In these task assignment systems, the BP strategy may outperform the FIFO strategy. Thus, the greater amount of time the BP strategy is ON, the more opportunities there are to optimize task-agent pairings using the BP strategy. However, if the OFF cycle is too short, there may be insufficient OFF sample data to calculate the OFF (“baseline”) performance accurately. As explained in detail below, embodiments of the present disclosure relate to task assignment systems with benchmarking that can work for longer ON cycles without sacrificing the accuracy of the benchmark.

The description herein describes network elements, computers, and/or components of a system and method for pairing strategies in a task assignment system that may include one or more modules. As used herein, the term “module” may be understood to refer to computing software, firmware, hardware, and/or various combinations thereof. Modules, however, are not to be interpreted as software, which is not implemented on hardware, firmware, or recorded on a non-transitory processor readable recordable storage medium (i.e., modules are not software per se). It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

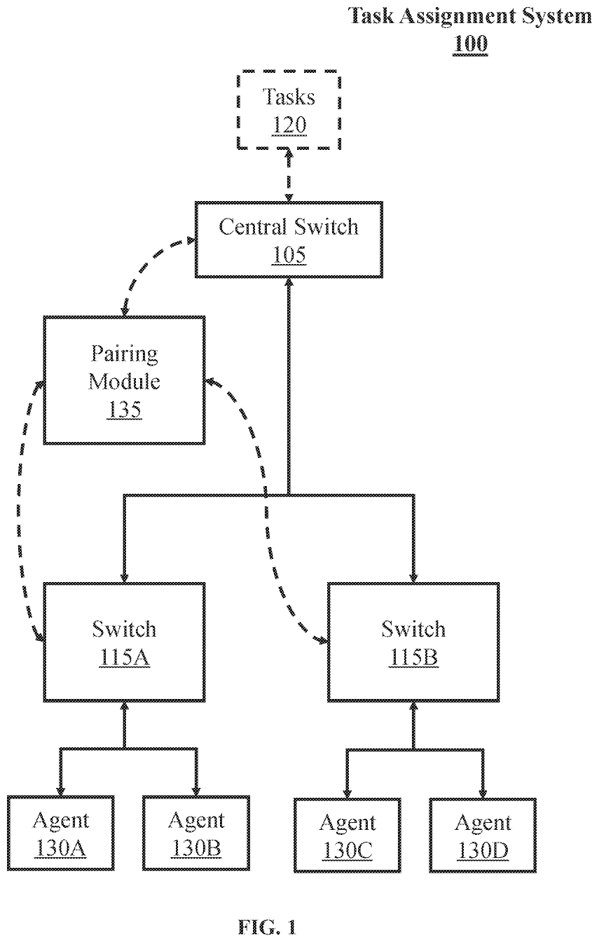

FIG. 1 shows a block diagram of a task assignment system 100 according to embodiments of the present disclosure. The task assignment system 100 may include a central switch 105. The central switch 105 may receive incoming tasks 120 (e.g., telephone calls, internet chat sessions, emails, etc.) or support outbound connections to contacts via a dialer, a telecommunications network, or other modules (not shown). The central switch 105 may include routing hardware and software for helping to route tasks among one or more queues (or subcenters), or to one or more Private Branch Exchange (“PBX”) or Automatic Call Distribution (ACD) routing components or other queuing or switching components within the task assignment system 100. The central switch 105 may not be necessary if there is only one queue (or subcenter), or if there is only one PBX or ACD routing component in the task assignment system 100.

If more than one queue (or subcenter) is part of the task assignment system 100, each queue may include at least one switch (e.g., switches 115A and 115B). The switches 115A and 115B may be communicatively coupled to the central switch 105. Each switch for each queue may be communicatively coupled to a plurality (or “pool”) of agents. Each switch may support a certain number of agents (or “seats”) to be logged in at one time. At any given time, a logged-in agent may be available and waiting to be connected to a task, or the logged-in agent may be unavailable for any of a number of reasons, such as being connected to another task, performing certain post-call functions such as logging information about the call, or taking a break. In the example of FIG. 1, the central switch 105 routes tasks to one of two queues via switch 115A and switch 115B, respectively. Each of the switches 115A and 115B are shown with two agents each. Agents 130A and 130B may be logged into switch 115A, and agents 130C and 130D may be logged into switch 115B.

The task assignment system 100 may also be communicatively coupled to a pairing module 135. The pairing module 135 may be a service provided by, for example, a third-party vendor. In the example of FIG. 1, the pairing module 135 may be communicatively coupled to one or more switches in the switch system of the task assignment system 100, such as central switch 105, switch 115A, and switch 115B. In some embodiments, switches of the task assignment system 100 may be communicatively coupled to multiple pairing systems. In some embodiments, the pairing module 135 may be embedded within a component of the task assignment system 100 (e.g., embedded in or otherwise integrated with a switch).

The pairing module 135 may receive information from a switch (e.g., switch 115A) about agents logged into the switch (e.g., agents 130A and 130B) and about incoming tasks 120 via another switch (e.g., central switch 105) or, in some embodiments, from a network (e.g., the Internet or a telecommunications network) (not shown). The pairing module 135 may process this information to determine which tasks should be paired (e.g., matched, assigned, distributed, routed) with which agents.

For example, in an L1 state, multiple agents may be available and waiting for connection to a task, and a task arrives at the task assignment system 100 via a network or the central switch 105. As explained above, without the pairing module 135, a switch will typically automatically distribute the new task to whichever available agent has been waiting the longest amount of time for an agent under a FIFO strategy, or whichever available agent has been determined to be the highest-performing agent under a PBR strategy. With the pairing module 135, contacts and agents may be given scores (e.g., percentiles or percentile ranges/bandwidths) according to a pairing model or other artificial intelligence data model, so that a task may be matched, paired, or otherwise connected to a preferred agent.

In an L2 state, multiple tasks are available and waiting for connection to an agent, and an agent becomes available. These tasks may be queued in a switch such as a PBX or ACD device. Without the pairing module 135, a switch will typically connect the newly available agent to whichever task has been waiting on hold in the queue for the longest amount of time as in a FIFO strategy or a PBR strategy when agent choice is not available. In some task assignment centers, priority queuing may also be incorporated, as previously explained. With the pairing module 135 in this L2 scenario, as in the L1 state described above, tasks and agents may be given percentiles (or percentile ranges/bandwidths, etc.) according to, for example, a model, such as an artificial intelligence model, so that an agent becoming available may be matched, paired, or otherwise connected to a preferred task.

In the task assignment system 100, the pairing module 135 may switch between pairing strategies and benchmark the relative performance of the task assignment system under each pairing strategy. The benchmarking results may help to determine which pairing strategy or combination of pairing strategies to use to optimize the overall performance of the task assignment system 100.

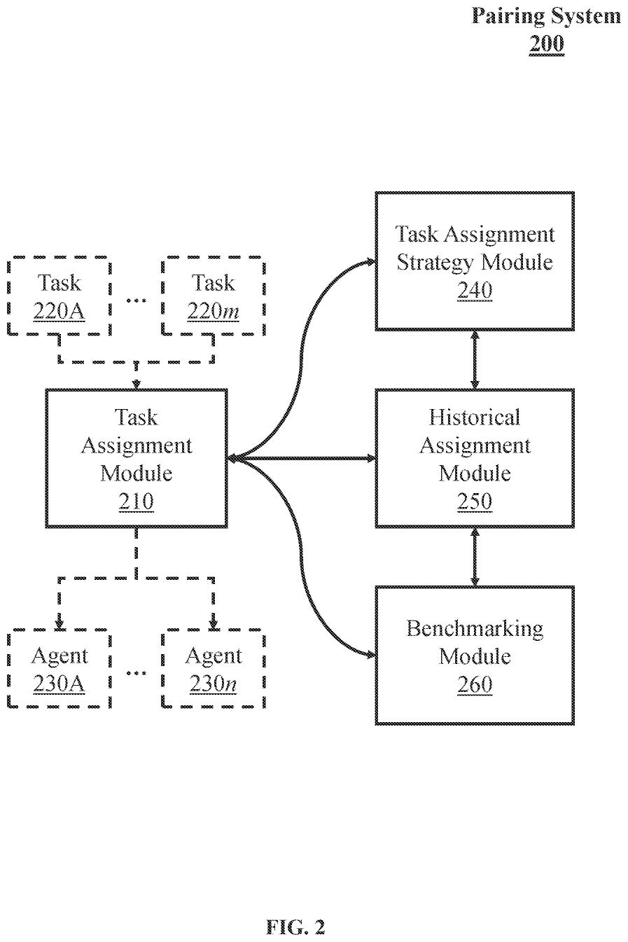

FIG. 2 shows a block diagram of a pairing system 200 according to embodiments of the present disclosure. The pairing system 200 may be included in a task assignment system (e.g., a contact center system) or incorporated in a component or module (e.g., a pairing module) of a task assignment system for helping to assign tasks (e.g., contacts) among various agents.

The pairing system 200 may include a task assignment module 210 that is configured to pair (e.g., match, assign) incoming tasks to available agents. In the example of FIG. 2, m tasks 220A-220m are received over a given period, and n agents 230A-230n are available during the given period. Each of the m tasks may be assigned to one of the n agents for servicing or other types of task processing. In the example of FIG. 2, m and n may be arbitrarily large finite integers greater than or equal to one. In a real-world task assignment system, such as a contact center system, there may be dozens, hundreds, etc. of agents logged into the contact center system to interact with contacts during a shift, and the contact center system may receive dozens, hundreds, thousands, etc. of contacts (e.g., telephone calls, internet chat sessions, emails, etc.) during the shift.

In some embodiments, a task assignment strategy module 240 may be communicatively coupled to and/or configured to operate in the pairing system 200. The task assignment strategy module 240 may implement one or more task assignment strategies (or “pairing strategies”) for assigning individual tasks to individual agents (e.g., pairing contacts with contact center agents). A variety of different task assignment strategies may be devised and implemented by the task assignment strategy module 240. In some embodiments, a FIFO strategy may be implemented in which, for example, the longest-waiting agent receives the next available task (in L1 environments) or the longest-waiting task is assigned to the next available agent (in L2 environments). In other embodiments, a PBR strategy for prioritizing higher-performing agents for task assignment may be implemented. Under PBR, for example, the highest-performing agent among available agents receives the next available task. In yet other embodiments, a BP strategy may be used for optimally assigning tasks to agents using information about either tasks or agents, or both. Various BP strategies may be used, such as a diagonal model BP strategy or a network flow BP strategy. See U.S. Pat. Nos. 9,300,802; 9,781,269; 9,787,841; and 9,930,115.

In some embodiments, a historical assignment module 250 may be communicatively coupled to and/or configured to operate in the pairing system 200 via other modules such as the task assignment module 210 and/or the task assignment strategy module 240. The historical assignment module 250 may be responsible for various functions such as monitoring, storing, retrieving, and/or outputting information about task-agent assignments that have already been made. For example, the historical assignment module 250 may monitor the task assignment module 210 to collect information about task assignments in a given period. Each record of a historical task assignment may include information such as an agent identifier, a task or task type identifier, offer or offer set identifier, outcome information, or a pairing strategy identifier (i.e., an identifier indicating whether a task assignment was made using a BP strategy, or some other pairing strategy such as a FIFO or PBR pairing strategy).

In some embodiments and for some contexts, additional information may be stored. For example, in a call center context, the historical assignment module 250 may also store information about the time a call started, the time a call ended, the phone number dialed, and the caller's phone number. For another example, in a dispatch center (e.g., “truck roll”) context, the historical assignment module 250 may also store information about the time a driver (i.e., field agent) departs from the dispatch center, the route recommended, the route taken, the estimated travel time, the actual travel time, the amount of time spent at the customer site handling the customer's task, etc.

In some embodiments, the historical assignment module 250 may generate a pairing model or a similar computer processor-generated model based on a set of historical assignments for a period of time (e.g., the past week, the past month, the past year, etc.), which may be used by the task assignment strategy module 240 to make task assignment recommendations or instructions to the task assignment module 210.

In some embodiments, a benchmarking module 260 may be communicatively coupled to and/or configured to operate in the pairing system 200 via other modules such as the task assignment module 210 and/or the historical assignment module 250. The benchmarking module 260 may benchmark the relative performance of two or more pairing strategies (e.g., FIFO, PBR, BP, etc.) using historical assignment information, which may be received from, for example, the historical assignment module 250. In some embodiments, the benchmarking module 260 may perform other functions, such as establishing a benchmarking schedule for cycling among various pairing strategies, tracking cohorts (e.g., base and measurement groups of historical assignments), etc. Benchmarking is described in detail for the contact center context in, e.g., U.S. Pat. No. 9,712,676, which is hereby incorporated by reference herein.

In some embodiments, the benchmarking module 260 may output or otherwise report or use the relative performance measurements. The relative performance measurements may be used to assess the quality of a pairing strategy to determine, for example, whether a different pairing strategy (or a different pairing model) should be used, or to measure the overall performance (or performance gain) that was achieved within the task assignment system while it was optimized or otherwise configured to use one pairing strategy instead of another.

In some embodiments, the pairing system 200 may use a FIFO strategy (or some other traditional pairing strategy, e.g., PBR) for some tasks and a BP strategy for other tasks. The pairing system 200 may cycle the BP strategy on and off, collecting outcome data during the ON (BP) cycle and the OFF (FIFO) cycle. The benchmarking module 260 may determine the relative performance gain of the BP strategy over the FIFO strategy.

Because the BP strategy may outperform the FIFO strategy, the greater amount of time the BP strategy is ON, the more opportunities there are to optimize task-agent pairings using the BP strategy. However, if the OFF cycle is too short, the historical assignment module may not collect sufficient OFF sample data for the benchmarking module 260 to calculate the OFF (“baseline”) performance or the overall benchmark accurately. To address this shortcoming, as will be described below, the pairing system 200 may transform (e.g., re-weigh, normalize, or otherwise adjust) ON data in a statistically valid way to simulate OFF sample data.

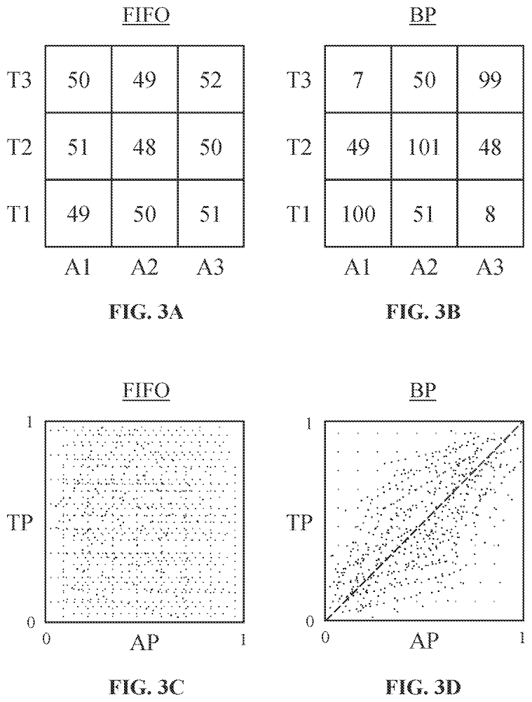

FIGS. 3A-3D show representative distributions of task-agent assignments according to embodiments of the present disclosure. These distributions are in agent-task space or agent percentile-task percentile (AP-TP) space (or caller or contact percentiles in call or contact center contexts). FIGS. 3A and 3B show discrete representations of the task-agent assignment distributions for a FIFO strategy and a diagonal model BP strategy, respectively. FIGS. 3C and 3D show continuous representations of the task-agent assignment distributions for a FIFO strategy and a diagonal model BP strategy, respectively.

In the discrete representations (FIGS. 3A and 3B), a simplified example task assignment system is shown to three agents (A1, A2, and A3) and three types of tasks (T1, T2, and T3). In FIG. 3A, for the FIFO strategy, an approximately uniform distribution of task assignments is expected. In this example, approximately the same number of each task type was assigned to each agent (e.g., 49 tasks of task type T1 were assigned to agent A1, 50 to agent A2, and 51 to agent A3).

In the diagonal model BP strategy (FIG. 3B), tasks are preferably assigned to agents centered around the “y=x” (TP=AP) diagonal. In this example, most of the T1 type of tasks were assigned to agent A1, most of the T2 type of tasks were assigned to agent A2, and most of the T3 type of tasks were assigned to agent A3. A smaller number of tasks were assigned to agents that were relatively close to the diagonal (e.g., T1 type of tasks assigned agent A2, T2 type of tasks assigned to agent A1 or A3, and T3 type of tasks assigned to agent A2). An even smaller number of tasks were assigned to agents that were farthest away from the diagonal (e.g., T1 type of tasks to agent A3 and T3 type of tasks to agent A1).

In the continuous representations (FIGS. 3C and 3D), each agent is assigned a percentile or other score, for example, represented in the range from 0 to 1. In this example, the agents' percentiles are normalized to be distributed and ordered evenly across the AP range from 0 to 1. Similarly, each type of task is assigned a median task type percentile or score. In this example, the task types' percentiles are normalized to be distributed and ordered evenly across the TP range from 0 to 1.

In FIG. 3C, for the FIFO strategy, an approximately uniform distribution of task assignments is expected, with each assignment represented by a dot in the AP-TP space. In the continuous representation of the diagonal model BP strategy (FIG. 3D), most task assignments are clustered around the “y=x” (TP=AP) diagonal, with fewer assignments (dots) appearing at greater distances from the diagonal.

These examples refer to a diagonal model BP strategy because it may be visualized and depicted graphically based on distance from the “y=x” (TP=AP) line in a Cartesian plane. However, these distributions will be similar for other BP strategies, such as BP based on “off-diagonal” techniques (e.g., a probabilistic network flow model). See U.S. Pat. No. 9,930,180, which is hereby incorporated by reference herein. In “off-diagonal” model BP strategies, most of the task assignments will be preferred pairings according to the model, with smaller numbers of task assignments for less-preferred pairings.

As described above, in benchmarking systems, a baseline performance measurement may be determined using OFF (e.g., FIFO) data. For example, in contact center contexts, the average conversion rate may be measured for all OFF calls in a sales queue of a contact center system. Similarly, a BP performance measurement may be determined using ON data, such as the average conversion rate for all ON calls. The ON and OFF performance measurements may be compared to give the relative performance or gain of the ON pairing strategy over the OFF pairing strategy (or multiple alternative strategies).

In such systems, it is usually necessary to run the OFF cycle long enough to get an adequate sample of historical task assignment outcomes for a statistically accurate measurement of gain with relatively small error (e.g., error bars). ON outcomes or other data are not used to measure OFF performance, and OFF outcomes or other data are not used to measure ON performance. Moreover, uniformly distributed pairings are statistically useful for feeding back in machine learning or other type of artificial intelligence model to refine or create a pairing model. When BP strategy is on, too few tasks are assigned to suboptimal pairings to measure the average performance of those pairings to update the model using ON data.

As explained in more detail below, in some embodiments of the present disclosure, implicit benchmarking techniques may be used, whereby some or all ON data may be used to simulate, estimate, or otherwise determine OFF performance. The ON data may be adjusted (e.g., reweighted) to give a statistically valid way of including the ON data in a measurement of OFF (e.g., FIFO or baseline performance). Moreover, in some embodiments, the proportion of calls paired using the ON strategy may approach or even reach 100%. For example, the task assignment system may use the ON strategy more than 80%, more than 90%, or even 100% of the time, and a statistically valid measurement of gain over baseline performance may still be measured.

In some embodiments, historical task assignments from ON data may be weighted to simulate the baseline pairing strategy. For example, if the baseline or OFF strategy is FIFO, the expected distribution (or “density”) of pairings is uniform throughout the AP-TP space. To simulate a uniform distribution from ON task assignments, some task assignments in low-density regions of the AP-TP space may be weighted more heavily. For example, if the density of historical task assignments in one region of the pairing space is 50% below the average density, the performance measurement of that portion of historical task assignments may be doubled or similarly weighted (or “re-weighted”) to approximate an average density of historical task assignments.

In some embodiments, a task assignment system may deliberately sample unexplored space. For example, if a particular region of the AP-TP space is unexplored (e.g., zero or otherwise too few tasks of type T3 assigned to agent A1), the pairing system may deliberately make an occasional suboptimal pairing of a T3 task with agent A1 to increase the sample size of T3-A1 assignments.

In some task assignment systems, the baseline (or OFF or alternative) pairing strategy may be a strategy other than FIFO. For example, the baseline pairing strategy may be a PBR strategy. In a PBR strategy, the expected density of historical task assignments is non-uniform. The expected distribution may be that higher-performing agents receive the most task assignments across all task types, and lower-performing agents receive the fewest task assignments across all task types. In this example, the ON data may be weighted to simulate the expected distribution of a PBR sample to determine the expected baseline performance even if ON data is collected most or all of the time (e.g., ON more than 80%, more than 90%, or even 100% of the time).

In some environments, a BP strategy may have a limited amount of choice or even no choice. For example, a no-choice environment arises when there is one agent available and one task waiting for assignment (i.e., an L0 environment). In an L0 environment, the BP strategy may pair the agent with the task even though it may be a suboptimal or less-preferred pairing. These L0 pairings may end up being made throughout the pairing space. Thus, in some embodiments, these L0 pairings from the ON sample may be preferably included as part of the OFF sample data. In some embodiments, it may be understood that the pairing strategy does not affect the likelihood of a particular outcome for that type of pairing. For example, a T1-A1 pairing may have a certain expected value (e.g., conversion rate) regardless of whether the T1-A1 pairing was made by an OFF or ON strategy. Thus, including T1-A1 pairing outcomes from the ON sample to determine OFF performance does not bias the average performance measurement (e.g., average conversion rate) of historical T1-A1 pairings.

In some embodiments, it may not be necessary to measure the conversion rate of each region of the pairing space separately for ON and OFF. Instead, the conversion rate may be determined using all task assignments made by both the ON and OFF pairing strategies. By using the combined ON and OFF task assignments, the sample size for all regions of the pairing space may be larger, thereby improving accuracy and reducing error when refining the pairing model.

In some embodiments, it may be preferred to measure both the separate ON versus OFF performance in addition to the combined ON and OFF performance. The ON versus OFF performance may represent what actually transpired in the task assignment system, so that any payment or other value associated with relative gain may be determined based solely on how actual ON task assignments performed compared to actual OFF task assignments. On the other hand, the combined ON and OFF performance may still be used for feedback to train and refine the BP pairing model.

In some embodiments, the BP pairing model is improved, trained, and/or refined by determining a performance for each feasible task-agent combination from the pairing space. Feasible task-agent combinations include actual pairing data from the pairing space, as well as alternative combinations of agents and tasks that did not actually transpire. For example, a task-agent combination may be feasible if an available agent and available task type have at least one skill in common. In other examples, a task-agent combination may be feasible if an available agent has at least all of the skills required by the available task type. In yet other embodiments, other heuristics for feasibility may be used.

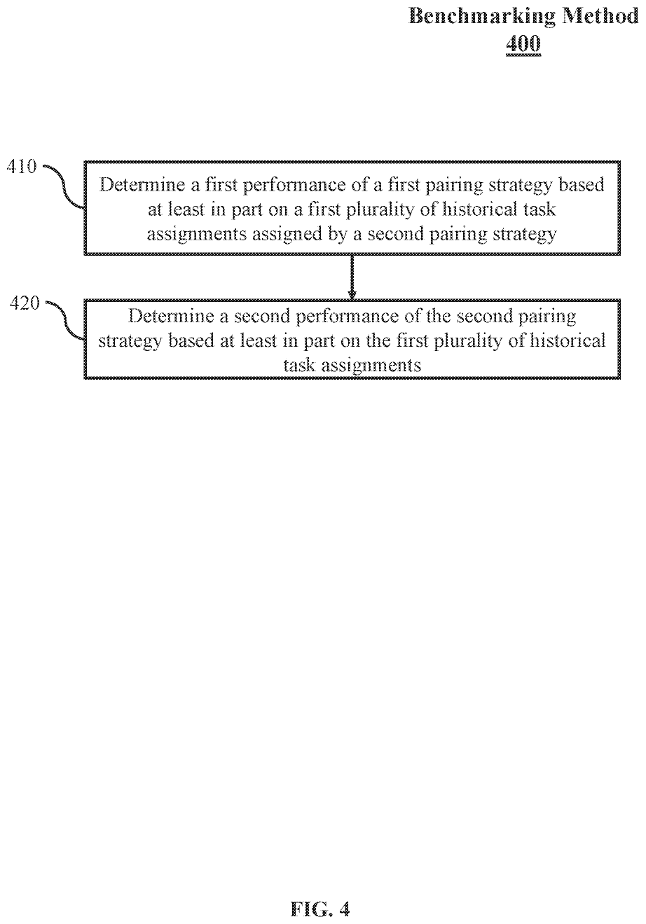

FIG. 4 shows a flow diagram of a benchmarking method 400 for benchmarking pairing strategies in a task assignment system (e.g., task assignment system 100) according to embodiments of the present disclosure.

The benchmarking method 400 may begin at block 410. At block 410, the benchmarking method 400 may determine a first performance of a first pairing strategy based at least in part on a first plurality of historical task assignments assigned by a second pairing strategy. For example, the first pairing strategy may a FIFO strategy, and the second pairing strategy may be a BP strategy. In some embodiments, the first performance may be determined solely on the first plurality of historical task assignments. In other embodiments, the first performance may be determined based in part further on a second plurality of historical task assignments assigned by the first pairing strategy.

The benchmarking method 400 may then proceed to block 420. At block 420, the benchmarking method 400 may determine a second performance of the second pairing strategy based at least in part on the first plurality of historical task assignments. The first plurality of historical task assignments may be weighted for determining the first performance of the first pairing strategy (block 410), and the first plurality of historical task assignments may be unweighted for determining the second performance of the second pairing strategy.

At this point it should be noted that task assignment in accordance with the present disclosure as described above may involve the processing of input data and the generation of output data to some extent. This input data processing and output data generation may be implemented in hardware or software. For example, specific electronic components may be employed in a behavioral pairing module or similar or related circuitry for implementing the functions associated with task assignment in accordance with the present disclosure as described above. Alternatively, one or more processors operating in accordance with instructions may implement the functions associated with task assignment in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes.

1. A method for benchmarking pairing strategies in a task assignment system, the method comprising:
determining, by at least one computer processor communicatively coupled to and configured to operate in the task assignment system, a first performance of a first pairing strategy based at least in part on a first plurality of historical task assignments assigned by a second pairing strategy.

2. The method of claim 1, wherein the task assignment system is a contact center system.

3. The method of claim 1, wherein the first pairing strategy is a first-in, first-out strategy.

4. The method of claim 1, wherein the second pairing strategy is a behavioral pairing strategy.

5. The method of claim 1, wherein the determining the first performance is further based at least in part on a second plurality of historical task assignments assigned by the first pairing strategy.

6. The method of claim 5, further comprising improving, by the at least one computer processor, a pairing model of the second pairing strategy by determining, based on both the first plurality of historical task assignments and the second plurality of historical task assignments, a performance for each of a plurality of feasible task-agent combinations.

7. The method of claim 1, wherein the first performance is based solely on the first plurality of historical task assignments assigned by the second pairing strategy.

8. The method of claim 1, wherein the task assignment system applies the second pairing strategy at least 90% of the time.

9. The method of claim 1, wherein the task assignment system applies the second pairing strategy 100% of the time.

10. The method of claim 1, wherein the determining the first performance further comprises weighting the first plurality of historical task assignments according to an expected distribution of task assignments when using the first pairing strategy.

11. The method of claim 1, further comprising determining, by the at least one computer processor, a second performance of the second pairing strategy based at least in part on the first plurality of historical task assignments.

12. The method of claim 11, wherein the first plurality of historical task assignments are weighted for determining the first performance of the first pairing strategy, and the first plurality of historical task assignments are unweighted for determining the second performance of the second pairing strategy.

13. A system for benchmarking pairing strategies in a task assignment system comprising:
at least one computer processor communicatively coupled to and configured to operate in the task assignment system, wherein the at least one computer processor is further configured to:
determine a first performance of a first pairing strategy based at least in part on a first plurality of historical task assignments assigned by a second pairing strategy.

14. The system of claim 13, wherein the task assignment system is a contact center system.

15. The system of claim 13, wherein the first pairing strategy is a first-in, first-out strategy.

16. The system of claim 13, wherein the second pairing strategy is a behavioral pairing strategy.

17. The system of claim 13, wherein the at least one computer processor is configured to determine the first performance further based at least in part on a second plurality of historical task assignments assigned by the first pairing strategy.

18. The system of claim 17, wherein the at least one computer processor is further configured to:
improve a pairing model of the second pairing strategy by determining, based on both the first plurality of historical task assignments and the second plurality of historical task assignments, a performance for each of a plurality of feasible task-agent combinations.

19. The system of claim 13, wherein the first performance is based solely on the first plurality of historical task assignments assigned by the second pairing strategy.

20. The system of claim 13, wherein the task assignment system applies the second pairing strategy at least 90% of the time.

21. The system of claim 13, wherein the task assignment system applies the second pairing strategy 100% of the time.

22. The system of claim 13, wherein the at least one computer processor is configured to determine the first performance by weighting the first plurality of historical task assignments according to an expected distribution of task assignments when using the first pairing strategy.

23. The system of claim 13, wherein the at least one computer processor is further configured to:
determine a second performance of the second pairing strategy based at least in part on the first plurality of historical task assignments.

24. The system of claim 23, wherein the first plurality of historical task assignments are weighted for determining the first performance of the first pairing strategy, and the first plurality of historical task assignments are unweighted for determining the second performance of the second pairing strategy.

25. An article of manufacture for benchmarking pairing strategies in a task assignment system comprising:
a non-transitory processor readable medium; and
instructions stored on the medium;
wherein the instructions are configured to be readable from the medium by at least one computer processor communicatively coupled to and configured to operate in the task assignment system and thereby cause the at least one computer processor to operate so as to:
determine a first performance of a first pairing strategy based at least in part on a first plurality of historical task assignments assigned by a second pairing strategy.

26. The article of manufacture of claim 25, wherein the task assignment system is a contact center system.

27. The article of manufacture of claim 25, wherein the first pairing strategy is a first-in, first-out strategy.

28. The article of manufacture of claim 25, wherein the second pairing strategy is a behavioral pairing strategy.

29. The article of manufacture of claim 25, wherein the instructions are configured to cause the at least one computer processor to operate so as to determine the first performance further based at least in part on a second plurality of historical task assignments assigned by the first pairing strategy.

30. The article of manufacture of claim 29, wherein the instructions are configured to cause the at least one computer processor to further operate so as to:
improve a pairing model of the second pairing strategy by determining, based on both the first plurality of historical task assignments and the second plurality of historical task assignments, a performance for each of a plurality of feasible task-agent combinations.
